(19) United States
(12) Patent Application Publication
(10) Pub. No.: US 2017/0016378 A9
(43) Pub. Date: Jan. 19, 2017

(54) CASTING PRODUCT AND MANUFACTURING METHOD THEREOF

(71) Applicant: Hyundai Motor Company, Seoul (KR)

(72) Inventors: Chul Jun Youm, Uijeongbu (KR); Soon Hyon Hwang, Hwaseong (KR); Jae Kwon Lee, Suwon (KR); Jong Hyuck Kim, Suwon (KR)

(21) Appl. No.: 14/481,027

(22) Filed: Sep. 9, 2014

(30) Foreign Application Priority Data
Feb. 18, 2014 (KR) 10-2014-0018567

(51) Int. Cl. F01P 3/02; B22C 9/24; F02F 7/00; B22D 25/02; F02F 1/40; F02F 1/14; B22C 9/10; B22D 27/04

(52) U.S. Cl. CPC F01P 3/02; B22C 9/105; B22C 9/24; B22D 27/04; B22D 25/02; F02F 1/40; F02F 1/14; F02F 7/0002; F01P 2003/021; F01P 2003/024

(57) ABSTRACT

The present invention relates to a casting product and a method of manufacturing the casting product. The manufacturing method of the casting product includes: manufacturing a salt core including a heterogeneous material part; manufacturing the casting product by inserting the salt core including the heterogeneous material part into a casting mold; injecting a molten metal into the casting mold; and removing the salt core from the casting product.

This application is based on and claims priority from Korean Patent Application No. 10-2014-0018567, filed on Feb. 18, 2014 in the Korean Intellectual Property Office, the disclosure of which is incorporated herein in its entirety by reference.

### TECHNICAL FIELD

The present invention relates to a casting product and a method manufacturing the casting product. In particular, the casting product which may include a heterogeneous material part mounted in the casting product, and the method of manufacturing the casting products are provided.

### BACKGROUND

Recently, a research for developing a method for improving fuel efficiency without reducing engine performance has been continuously performed in a vehicle industry and such research may include developing an efficient cooling system of an engine.

In related arts, for efficiently cooling the engine, a system in which cooling water is supplied to a cylinder block or a cooling water jacket formed in a cylinder head by driving a cooling water pump and is then circulated has been used. Meanwhile, a flow rate of the cooling water may increase, and accordingly, the power driving the cooling water pump may increase. In other words, since the power is supplied from the engine, fuel efficiency of the engine may be reduced when additional power from the engine is used to drive the cooling water pump.

On the other hand, when a portion of the power from the engine used to drive the cooling water pump decreases, the flow rate of the cooling water is subsequently decrease, and thus the engine may not be sufficiently cooled, thereby degrading fuel efficiency.

In view above, since both increase and the decrease in the flow rate of the cooling water in the engine which has been currently manufactured may not be sufficient for fuel efficiency of the engine, a method of increasing cooling efficiency of the engine without controlling the flow rate of the cooling water may be desired.

The description provided above as a related art of the present invention is merely for helping understanding of the background of the present invention and should not be construed as being included in the related art known by those skilled in the art.

### SUMMARY OF THE INVENTION

Accordingly, the present invention may provide a technical solution to the above-mentioned problems occurring in related arts. In particular, the present invention provides a casting product having a heterogeneous material part integrated in the casting product to improve cooling efficiency of an engine, and a method of manufacturing the casting products.

In one aspect of the present invention, a method of manufacturing a casting product may include: an operation S10 of manufacturing a salt core including a heterogeneous material part; an operation S20 of manufacturing the casting product by inserting the salt core including the heterogeneous material part into a casting mold and then injecting a molten metal into the casting mold; and an operation S30 of removing the salt core from the casting product.

The operation S10 may include an operation S12 of mounting the heterogeneous material part in a part mounting groove of a salt core mold having the part mounting groove in which the heterogeneous material part to be integrated with the casting product is able to be mounted.

The operation S10 may further include an operation S14 of injecting the salt core into the salt core mold and sintering the salt core after the operation S12.

The operation S10 may further include an operation S16 of removing the salt core mold in a state in which the sintered salt core including the heterogeneous material part remains after the operation S14.

In other aspect of the present invention, the method of manufacturing the casting product may include: manufacturing a salt core including a heterogeneous material part; manufacturing the casting product by inserting the salt core including the heterogeneous material part into a casting mold and then injecting a molten metal into the casting mold; and removing the salt core from the casting product.

Particularly, for manufacturing the salt core including the heterogeneous material part, the heterogeneous material part may be mounted in a part mounting groove of a salt core mold having the part mounting groove in which the heterogeneous material part to be integrated with the casting product is able to be mounted. In addition, the salt core may be injected into the salt core mold and sintered after mounting the heterogeneous material part in the part mounting groove of the salt core mold. The salt core mold in a state in which the sintered salt core including the heterogeneous material part remains may be removed after injecting and sintering the salt core.

In an exemplary embodiment, the casting product may be a cylinder block. In addition, the heterogeneous material part may be a heat sink which is inserted into the cylinder block to cool the cylinder block. In particular, the heat sink may be adjacent to a cooling water jacket formed in the cylinder block.

In another exemplary embodiment, the casting product may be a cylinder head. In addition, the heterogeneous material part may be a heat sink which is inserted into the cylinder head to cool the cylinder head. In particular, heat sink may be in contact with or be adjacent to a cooling water jacket formed in the cylinder head.

According to various exemplary embodiments, a release agent may be applied between the part mounting groove and the heterogeneous material part. Furthermore, the injection of the molten metal into the casting mold may be performed by a high pressure die casting (HPDC) method.

In another aspect of the present invention, a casting product having an empty space formed therein may include: a heat sink configured to be inserted into the casting product.

In an exemplary embodiment, the casting product may be a cylinder block. In addition, the cylinder block may have a cooling water jacket and a combustion chamber and the heat sink may be disclosed between the cooling water jacket and an inner wall of the combustion chamber. In particular, the heat sink may be adjacent to the cooling water jacket.

In another exemplary embodiment, the casting product may be a cylinder head. In particular, the cylinder head may have a cooling water jacket and the heat sink may be in contact with or be adjacent to the cooling water jacket.

### BRIEF DESCRIPTION OF THE DRAWINGS

The above and other objects, features and advantages of the present invention will be more apparent from the following detailed description taken in conjunction with the accompanying drawings, in which:

FIG. 1 shows an exemplary process of a method of manufacturing a casting product according to an exemplary embodiment of the present invention;

FIG. 2 shows a salt core mold having an exemplary heterogeneous material part, i.e. heat sink, integrated in an exemplary cylinder block according to an exemplary embodiment of the present invention;

FIGS. 3(A)-3(E) schematically illustrate processes of a manufacturing method of a casting product according to an exemplary embodiment of the present invention, where FIG. 3A shows an exemplary heat sink mounted in a part mounting groove of a salt core mold; FIG. 3B shows the heat sink detached from the salt core mold together with the salt core; FIG. 3C shows the heat sink and the salt core inserted into a cylinder block mold; FIG. 3D shows an exemplary cylinder block manufactured by injecting the molten metal into the molten metal filling space formed in the cylinder block mold; and FIG. 3E shows an exemplary final product formed by removing the salt core from the cylinder block;

FIG. 4 shows a salt core including a heat sink according to an exemplary embodiment of the present invention;

FIG. 5 shows a longitudinal-sectional view of an exemplary cylinder block according to an exemplary embodiment of the present invention;

FIG. 6 shows a salt core mold having an exemplary heterogeneous material part, i.e. heat sink, integrated in an exemplary cylinder head according to another exemplary embodiment of the present invention;

FIG. 7 shows a salt core including a heat sink according to another exemplary embodiment of the present invention;

FIG. 8 shows an exemplary cylinder head according to an exemplary embodiment of the present invention; and

FIG. 9 shows a cross-sectional view of the cylinder head taken along line IX-IX of FIG. 8.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, various exemplary embodiments of the present invention will be described in detail with reference to the accompanying drawings. However, the present invention will not be limited or restricted to the exemplary embodiments below.

Terms and words used in the present specification and claims are not to be construed as a general or dictionary meaning but are to be construed as meaning and concepts meeting the technical ideas of the present invention based on a principle that the inventors can appropriately define the concepts of terms in order to describe their own inventions in best mode.

It is to be noted that sizes of each component or a specific portion configuration the component are exaggerated, omitted or schematically illustrated for convenience of explanation and clarity. Therefore, the size of each component does not exactly reflect its real size. When it is determined that a detailed description of the known function and configuration related to the present invention may obscure the gist of the present invention, the detailed description thereof will be omitted.

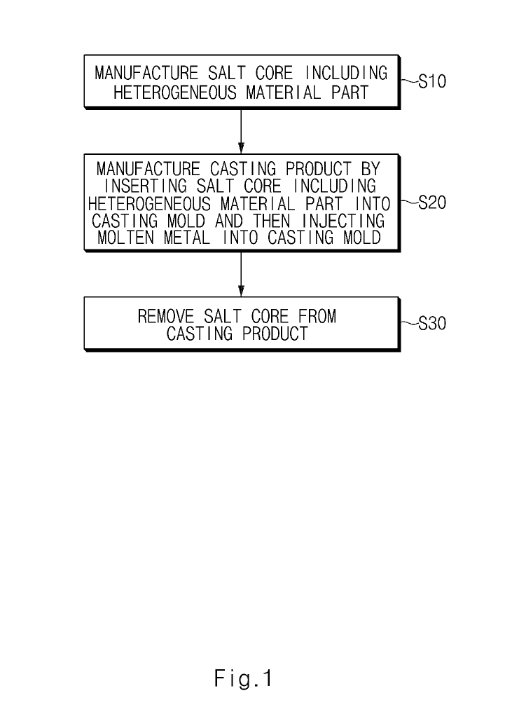

FIG. 1 shows an exemplary process in a method of manufacturing a casting product according to an exemplary embodiment of the present invention. In one aspect, as shown in FIG. 1, a manufacturing method of a casting product according to an exemplary embodiment of the present invention may include: an operation S10 of manufacturing a salt core 4 including a heterogeneous material part 2; an operation S20 of manufacturing a casting product 10 by inserting the salt core 4 including the heterogeneous material part 2 into a casting mold 8 and then injecting a molten metal into the casting mold 8; and an operation S30 of removing the salt core 4 from the casting product 10.

In particular, the operation S10 may include an operation S12 of mounting the heterogeneous material part 2 in a part mounting groove 6A of a salt core mold 6 having the part mounting groove 6A in which the heterogeneous part 2 to be molded integrally with the casting product 10 may be mounted, an operation S14 of injecting the salt core 4 into the salt core mold 6 and sintering the salt core after the operation S12, and an operation S16 of removing the salt core mold 6 in a state in which the sintered salt core 4 including the heterogeneous material part 2 remains after the operation S14. In the manufacturing method of the casting product according an exemplary embodiment of the present invention, since the manufacturing process may include finally removing the salt core 4 from the salt core mold 6, a final casting product 10 may have an empty space in which the salt core 4 is formed.

In another aspect of the present invention, the method of manufacturing the casting product may include: manufacturing a salt core including a heterogeneous material part; manufacturing the casting product by inserting the salt core including the heterogeneous material part into a casting mold and then injecting a molten metal into the casting mold; and removing the salt core from the casting product.

Particularly, for manufacturing the salt core including the heterogeneous material part, the heterogeneous material part may be mounted in a part mounting groove of a salt core mold having the part mounting groove in which the heterogeneous material part to be integrated with the casting product is able to be mounted. In addition, the salt core may be injected into the salt core mold and sintered after mounting the heterogeneous material part in the part mounting groove of the salt core mold. The salt core mold in a state in which the sintered salt core including the heterogeneous material part remains may be removed after injecting and sintering the salt core. In such methods the casting product suitably may be a cylinder block, including where the heterogeneous material part is a heat sink which is inserted into the cylinder block to cool the cylinder block. In such aspects, the heat sink suitably may be adjacent to a cooling water jacket formed in the cylinder block.

Hereinafter, the present invention will be described in more detailed exemplary embodiments.

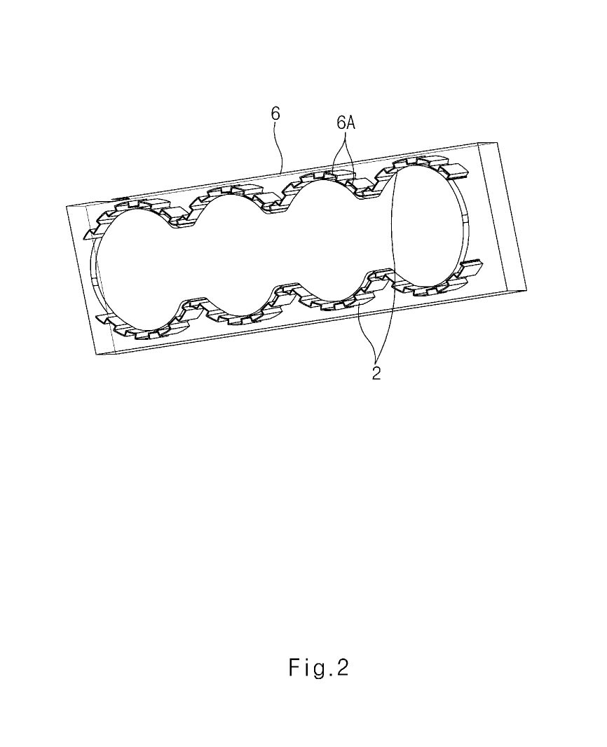

FIG. 2 shows an exemplary salt core mold 6 having a heterogeneous material part 2 mounted therein according to an exemplary embodiment of the present invention, wherein the casting product 10 is a cylinder block.

In an exemplary embodiment of the present invention, as shown in FIG. 2, the salt core mold 6 may have a part mounting groove 6A in which the heterogeneous material part 2 to be integrated with the cylinder block 10 may be mounted. In particular, FIG. 2 shows an exemplary heterogeneous material part 2 is mounted in the part mounting groove 6A after the operation of S12. In addition, the heterogeneous material part 2 may be a heat sink which is inserted into the cylinder block 10 to cool the cylinder block 10. Hereinafter, an exemplary heat sink as of heterogeneous material part 2 will be described.

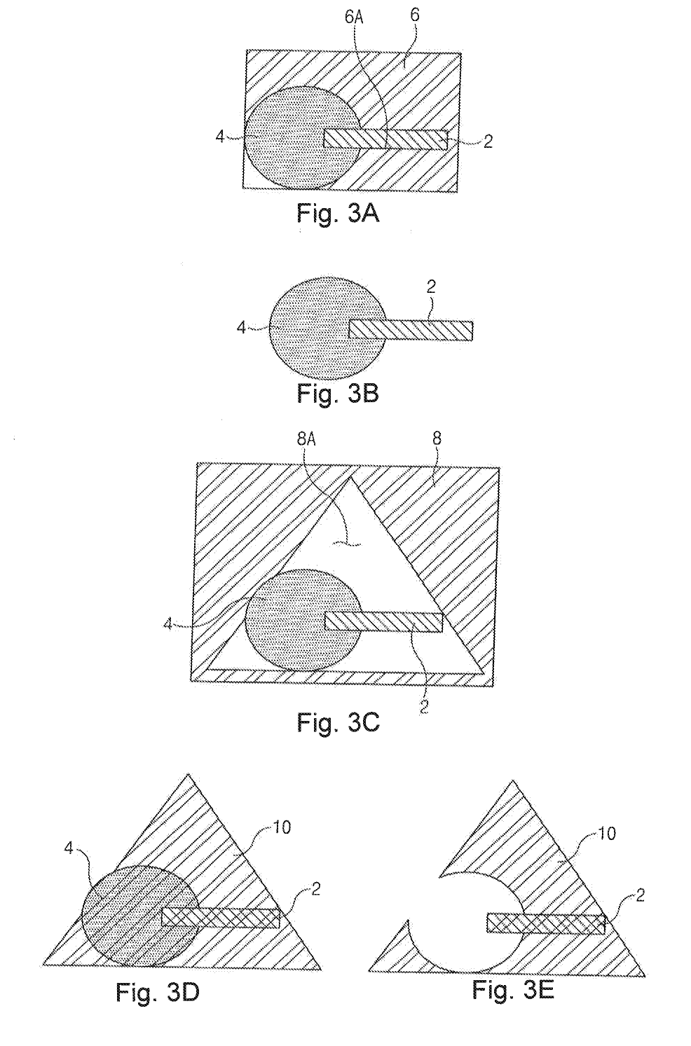

FIGS. 3(A)-3(E) schematically show a method of manufacturing a casting product according to an exemplary embodiment of the present invention. In particular, the method of manufacturing a cylinder block 10 according to an exemplary embodiment of the present invention will be described in detail with reference to FIG. 3.

In FIG. 3A, an exemplary heat sink 2 may be mounted in the part mounting groove 6A of the salt core mold 6. Subsequently, the salt core 4 may be injected into the salt core mold 6 and sintered according to exemplary operations of S12 and S14. In addition, FIG. 3B shows in an exemplary operation S16, during which the heat sink 2 may be detached from the salt core mold 6 together with the salt core 4. In particular, a release agent may be applied between the part mounting groove 6A and the heat sink 2. Moreover, the heat sink 2 to which the release agent is applied may be mounted in the part groove 6A; or the heat sink 2 may be mounted in the part mounted groove 6A to which the release agent is applied.

Further in FIG. 3B, when the operation S14 is completed, the operation S16 of removing the salt core mold 6 from the produced heat sink 2 and the salt core may be performed.

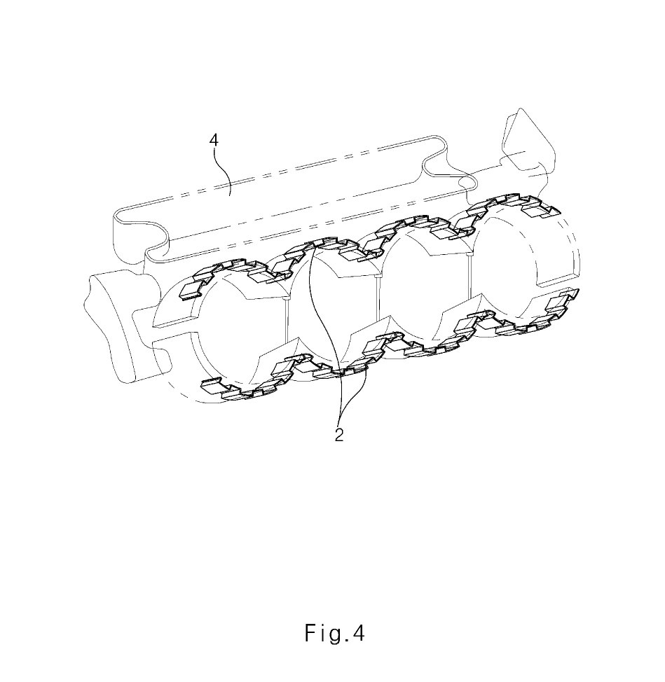

FIG. 4 shows an exemplary embodiment of a salt core including a heat sink according to an exemplary embodiment of the present invention. In particular, the heat sink after an exemplary operation S16 in FIG. 3B may be implemented. As shown in FIG. 3C, the heat sink 2 and the salt core 4 may be inserted into a cylinder block mold 8. As a result, a molten metal filling space 8A may be formed between the cylinder block mold 8 and the heat sink 2 and between the cylinder block 10 and the salt core 4. In particular, the cylinder block 10 may be manufactured by injecting the molten metal into the molten metal filling space 8A. According to various exemplary embodiments of the present invention, a process of injecting the molten metal may be performed by, without limitation, a high pressure die casting (HPDC) method.

In an exemplary embodiment of the present invention, a method of installing a core in the cylinder block mold 8 may be included in order to form a space in which the cylinder may perform a reciprocating motion in the cylinder block 10. When the core is manufactured as a sand core, the core may not withstand a pressure applied from a high pressure molten metal injected into the molten metal filling space 8A by the HPDC method and may be broken. Since the salt core 4 may be used in various exemplary embodiments of the present invention, the heterogeneous material part 2 having a thin thickness such as the heat sink 2 may be mounted in the cylinder block 10. In addition, since the HPDC method may be used to inject the molten metal in various exemplary embodiments, the production cost may be reduced compared to a general casting method and the productivity may be increased.

FIG. 3D shows an exemplary cylinder block 10 which may be manufactured by injecting the molten metal into the molten metal filling space 8A formed in the cylinder block mold 8; sintering; and removing the cylinder block 10 from the cylinder block mold 8. In FIG. 3E, an exemplary final product may be formed from an exemplary operation S30 of removing the salt core 4 from the cylinder block 10.

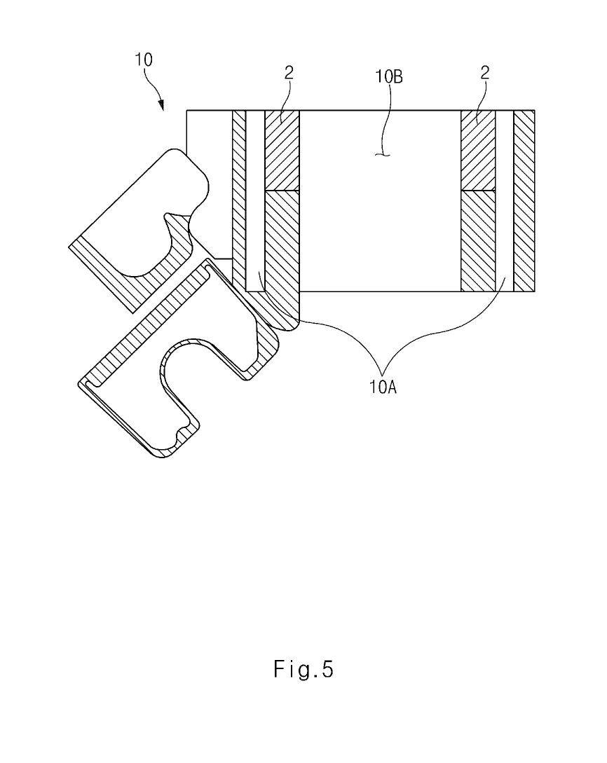

FIG. 5 shows a sectional view of a cylinder block according to an exemplary embodiment of the present invention. In FIG. 5, an exemplary cylinder block 10 may include cooling water jackets 10A and a combustion chamber 10B, wherein the heat sink 2 may be disposed between the cooling water jacket 10A and an inner wall of the combustion chamber 10B. In particular, since the heat sink 2 may receive and cool heat from the cylinder block 10, the heat sink 2 may be installed adjacent to the cooling water jacket 10A which may be formed in the cylinder block 10.

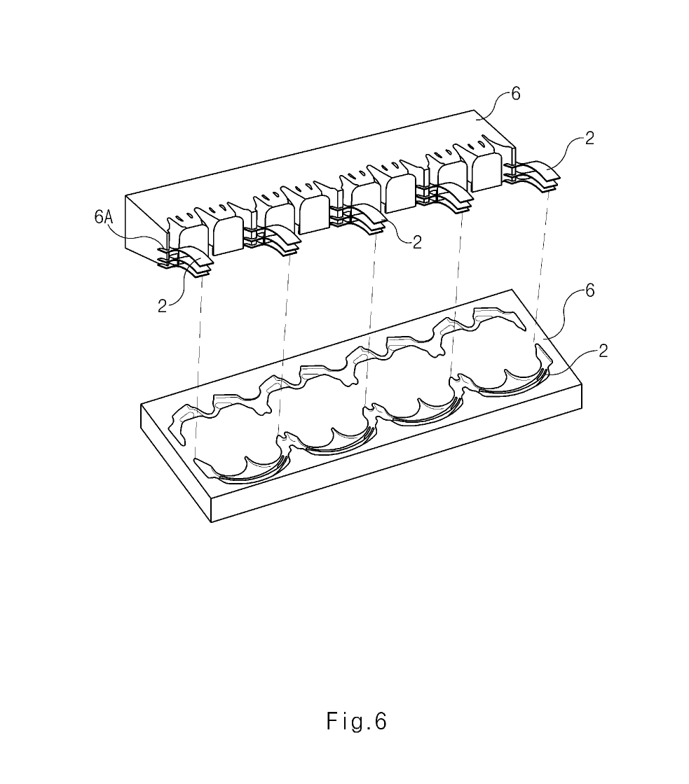

FIG. 6 shows a salt core mold having an exemplary heterogeneous material part 2, i.e. heat sink, mounted in an exemplary cylinder head according to another exemplary embodiment of the present invention. In particular, the casting product 10 may be the cylinder head, which may be manufactured by the same method described above, except a specific arrangement of the heterogeneous material part 2. Hereafter, parts which are different from those described above will be mainly described.

In FIG. 6 according to another exemplary embodiment, the heterogeneous material part 2 may be a heat sink which may be inserted into the cylinder head 10 to cool the cylinder head 10. In particular, the salt core mold 6 may have a part mounting groove 6A in which the heat sink 2 to be integrated with the cylinder head 10 may be mounted after an exemplary operation S12. Although FIG. 6 shows an example in which the salt core mold 6 is divided into an upper mold and a lower mold and the part mounting groove 6A is formed in the upper mold and the lower mold, respectively, the other exemplary embodiments of the present invention may include a modified example in which the upper mold and the lower mold are integrated.

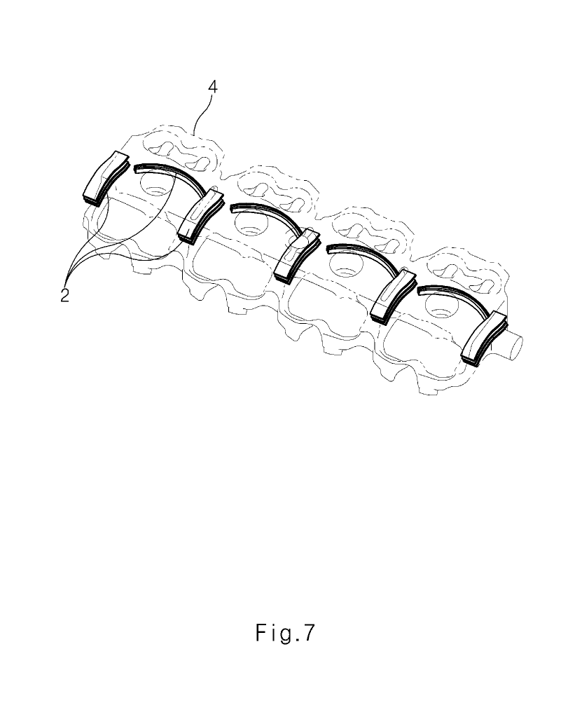

In addition, FIG. 7 shows an exemplary salt core including an exemplary heat sink according to another exemplary embodiment of the present invention. The salt core 4 including the heat sink as shown in FIG. 7 may be inserted into an exemplary cylinder head mold 8. As a result, a molten metal filling space 8A may be formed between the cylinder head mold 8 and the heat sink 2 and between the cylinder head 10 and the salt core 4, which may correspond to a state shown in FIG. 3C. In particular, the method may include installing the salt core 4 in the cylinder head mold 8 to manufacture the cylinder head 10. When the salt core 4 is used, since a gate for determining a position of the heterogeneous material part 2 may not be required, production cost of the cylinder head 10 may be reduced and strength of the cylinder head 10 may be increased. In addition, although the heterogeneous material part 2, such as the heat sink, has a thin thickness, it may be easily mounted in the cylinder head 10.

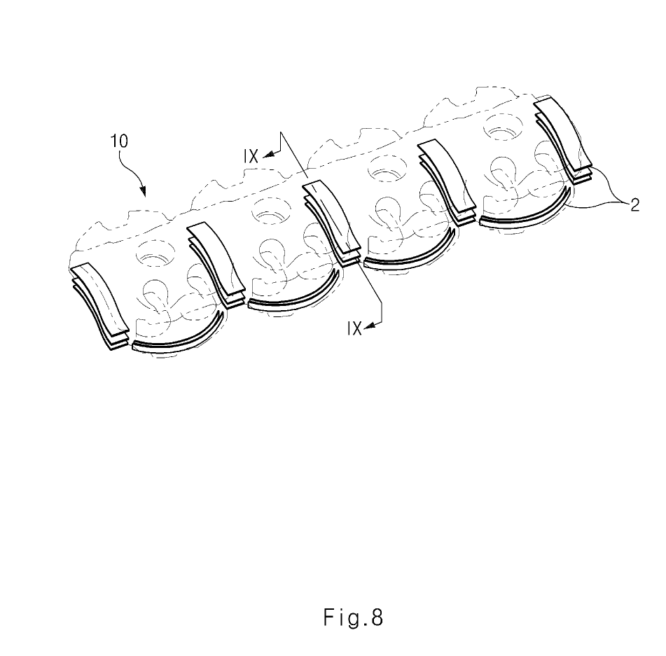

FIG. 8 shows an exemplary cylinder head according to another exemplary embodiment of the present invention which may correspond to a final product in FIG. 3E after an exemplary operation S30 in FIG. 3D of removing the salt core 4 from the cylinder head 10.

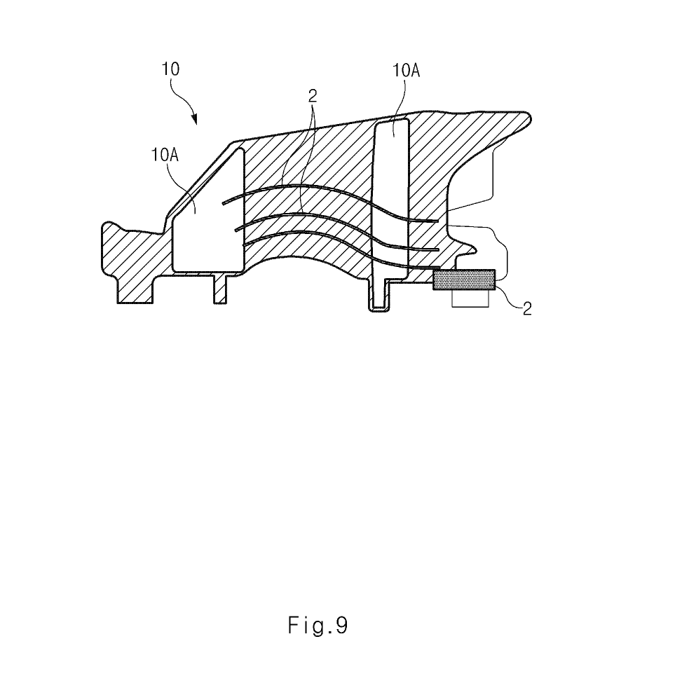

FIG. 9 shows a cross-sectional view of the exemplary cylinder head taken along line IX-IX in FIG. 8. In particular, since the cylinder head 10 according to another exemplary embodiment of the present invention may include the cooling water jacket 10A and the heat sink 2 may receive and cool heat from the cylinder head 10, the heat sink 2 may be installed in contact with or adjacent to the cooling water jacket 10A which may be formed in the cylinder head 10.

According to the exemplary embodiments of the present invention, since the salt core 4 may have significantly improved strength in contrary to the sand core which is used in conventional arts, particularly for the part having a thin thickness, for example, the heat sink 2, the salt core 4 may be installed at any desired parts of the casting product 10 and may be integrated with the casting product 10. In addition, cooling efficiency of an engine may be improved by installing the heterogeneous material part 2, for example, heat sink 2, in the casting product 10 without controlling a flow rate of the cooling water.

According to the exemplary embodiments of the present invention, the casting product having the heterogeneous material part inserted thereinto, and the method manufacturing the casting products may be provided, thereby providing the engine with improved cooling efficiency without reducing the fuel efficiency.

The present invention has been described in connection with the exemplary embodiments. However, modifications and variations can be made without departing from the scope of the present invention. The scope of the present invention is not construed as being limited to the described exemplary embodiments but is defined by the appended claims as well as equivalents thereto.

What is claimed is:

1. A method of manufacturing a casting product, comprising:
an operation S10 of manufacturing a salt core including a heterogeneous material part;
an operation S20 of manufacturing the casting product by inserting the salt core including the heterogeneous material part into a casting mold and then injecting a molten metal into the casting mold; and
an operation S30 of removing the salt core from the casting product.

2. The manufacturing method according to claim 1, wherein the operation S10 includes an operation S12 of mounting the heterogeneous material part in a part mounting groove of a salt core mold having the part mounting groove in which the heterogeneous material part to be integrated with the casting product is able to be mounted.

3. The manufacturing method according to claim 2, wherein the operation S10 further includes an operation S14 of injecting the salt core into the salt core mold and sintering the salt core, after the operation S12.

4. The manufacturing method according to claim 3, wherein the operation S10 further includes an operation S16 of removing the salt core mold in a state in which the sintered salt core including the heterogeneous material part remains, after the operation S14.

5. The manufacturing method according to claim 1, wherein the casting product is a cylinder block.

6. The manufacturing method according to claim 5, wherein the heterogeneous material part is a heat sink which is inserted into the cylinder block to cool the cylinder block.

7. The manufacturing method according to claim 6, wherein the heat sink is adjacent to a cooling water jacket formed in the cylinder block.

8. The manufacturing method according to claim 1, wherein the casting product is a cylinder head.

9. The manufacturing method according to claim 8, wherein the heterogeneous material part is a heat sink which is inserted into the cylinder head to cool the cylinder head.

10. The manufacturing method according to claim 9, wherein the heat sink is in contact with or is adjacent to a cooling water jacket formed in the cylinder head.

11. The manufacturing method according to claim 2, wherein in the operation S12, a release agent is applied between the part mounting groove and the heterogeneous material part.

12. The manufacturing method according to claim 1, wherein in the operation S20, the injection of the molten metal into the casting mold is performed by a high pressure die casting (HPDC) method.

13. A casting product having an empty space formed therein, the casting product comprising:
a heat sink configured to be inserted into the casting product.

14. The casting product according to claim 13, wherein the casting product is a cylinder block.

15. The casting product according to claim 14, wherein the cylinder block has a cooling water jacket and a combustion chamber and the heat sink is disclosed between the cooling water jacket and an inner wall of the combustion chamber.

16. The casting product according to claim 14, wherein the heat sink is adjacent to the cooling water jacket.

17. The casting product according to claim 13, wherein the casting product is a cylinder head.

18. The casting product according to claim 17, wherein the cylinder head has a cooling water jacket and the heat sink is in contact with or is adjacent to the cooling water jacket.

19. A method of manufacturing a casting product, comprising:
manufacturing a salt core including a heterogeneous material part;
manufacturing the casting product by inserting the salt core including the heterogeneous material part into a casting mold and injecting a molten metal into the casting mold; and
removing the salt core from the casting product.

20. The method of claim 19, wherein, for manufacturing the salt core, the heterogeneous material part is mounted in a part mounting groove of a salt core mold having the part mounting groove in which the heterogeneous material part to be integrated with the casting product is able to be mounted.
